(19) United States
(12) Patent Application Publication
(10) Pub. No.: US 2015/0201664 A1
(43) Pub. Date: Jul. 23, 2015

(54) CUSTOM SHAPED HOT DOGS, SAUSAGES, OR OTHER FOOD PRODUCTS, MANUFACTURING SYSTEMS AND METHODS THEREFOR

(71) Applicant: Ronald Smith, Roundrock, TX (US)

(72) Inventor: Ronald Smith, Roundrock, TX (US)

(21) Appl. No.: 14/577,679

(22) Filed: Dec. 19, 2014

Related U.S. Application Data
(60) Provisional application No. 61/920,317, filed on Dec. 23, 2013.

(51) Int. Cl. A23L 1/31; A23L 1/00

(52) U.S. Cl. CPC A23L 1/31; A23L 1/0073; A23V 2002/00

(57) ABSTRACT

The disclosure is related to custom shaped hot dogs, sausages, or other food products, manufacturing systems, and methods therefor. Hot dogs can be manufactured in different shapes and sizes. During manufacturing, a hot dog mixture can be placed into a mold, which can be made in a variety of geometric configurations. The hot dog mixture can cook in the molds, taking on the shape of the mold. The resulting food product can be distributed with the mold in place (such as a sausage casing) or removed.

### BACKGROUND

Traditional hot dogs are available in only one shape, an elongated tube that has a round cross section.

### BRIEF DESCRIPTION OF THE DRAWINGS

FIG. 1a is a diagram of an embodiment of custom shaped food products, in accordance with certain embodiments of the present disclosure;

FIG. 1b is a diagram of an embodiment of custom shaped food products , in accordance with certain embodiments of the present disclosure;

FIG. 2a is a diagram of an embodiment of custom shaped food products , in accordance with certain embodiments of the present disclosure;

FIG. 2b is a diagram of an embodiment of custom shaped food products , in accordance with certain embodiments of the present disclosure;

FIG. 3 is a diagram of embodiments of custom shaped food products , in accordance with certain embodiments of the present disclosure;

FIG. 4 is a diagram of manufacturing systems and methods for custom shaped food products, in accordance with certain embodiments of the present disclosure;

FIG. 5 is a diagram of manufacturing systems and methods for custom shaped food products, in accordance with certain embodiments of the present disclosure;

FIG. 6 is a diagram of manufacturing systems and methods for custom shaped food products, in accordance with certain embodiments of the present disclosure;

FIG. 7 is a diagram of manufacturing systems and methods for custom shaped food products, in accordance with certain embodiments of the present disclosure;

FIG. 8 is a diagram of manufacturing systems and methods for custom shaped food products, in accordance with certain embodiments of the present disclosure;

FIG. 9 is a diagram of manufacturing systems and methods for custom shaped food products, in accordance with certain embodiments of the present disclosure; and

FIG. 10 is a flowchart of a method of manufacturing systems and methods for custom shaped food products, in accordance with certain embodiments of the present disclosure.

### DETAILED DESCRIPTION

In the following detailed description of the embodiments, reference is made to the accompanying drawings which form a part hereof, and in which are shown by way of illustrations. It is to be understood that features of the various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

Hot dogs are a food enjoyed by millions of Americans and can often be found at birthday parties, sporting events, barbeques, and on the plates of hungry campers. Hot dogs can have a variety of ingredients, such as spices, flavorings, starches, binders, fillers, food colors, and a meat or vegetable base, chosen to meet the needs and tastes of hot dog eaters. A meat base of a hot dog can include pork, beef, turkey, chicken, other type of meat, or any combination thereof. A vegetable base can have soybeans, potatoes, wheat, or other ingredients, or a combination thereof.

Hot dogs can be made by first grinding a base ingredient to a consistency that can easily be mixed with other ingredients, such as flavorings, binders, and fillers. The mixture can then be pureed into a paste and deposited into an elongated mold(s) of various shapes and sizes for cooking When the mixture is cooked, it can be cooled and removed from the mold for packaging. The molds may be an organic material, such as sausage casing, or non-organic material, such as fabrics, metals, plastics, composites, synthetic materials, or any combination thereof, and can be rigid or flexible.

Referring to Figures la and lb, diagrams of an embodiment of custom shaped food products are shown and generally designated 100. Figure la can be the view of a top of an elongated food product such as a hot dog or sausage having a wedge or triangular shape with a rounded top edge. Figure lb can be a custom cross-sectional shape of the elongated food product of Figure la, taken at line 2.

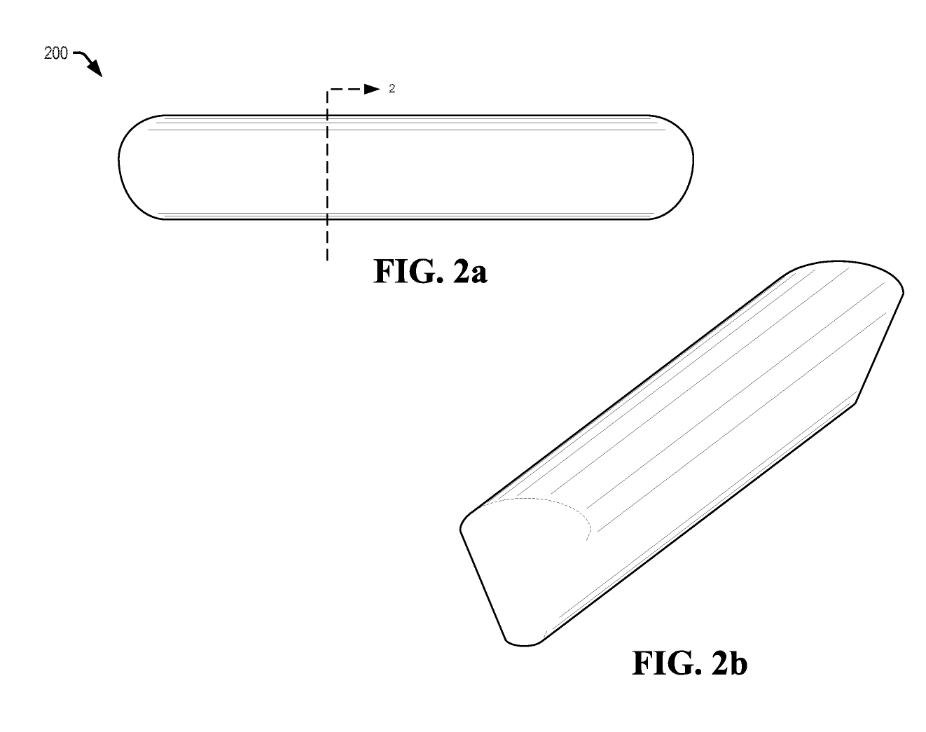

Referring to FIGS. 2a and 2b, diagrams of an embodiment of custom shaped food products are shown and generally designated 200. FIG. 2a can be the view of a top of the hot dog of diagram 100 and FIG. 2b can be a three dimensional cross section of the hot dog of FIG. 2a, taken at line 2 and extending to the back end of the hot dog.

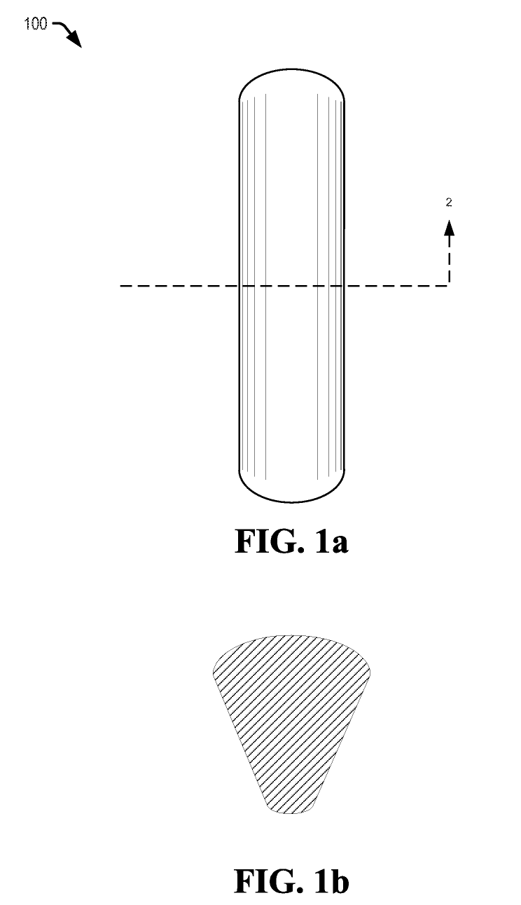

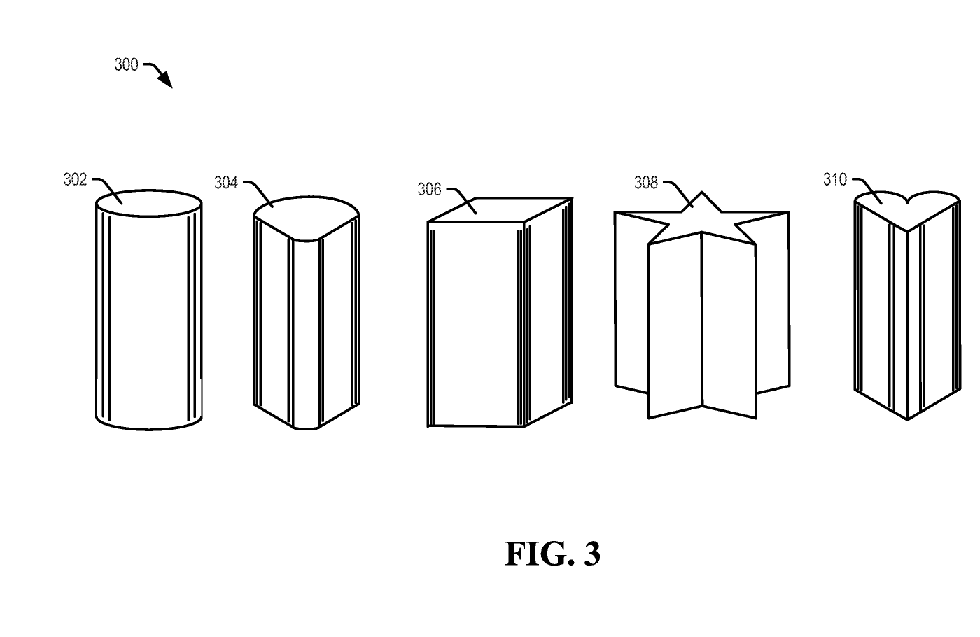

Referring to FIG. 3, a diagram of embodiments of custom shaped food products are shown and generally designated 300. Molds can be used to form a mixture into an elongated food product having a custom shape. In some cases, the molds can be used to form a mixture into shapes having non-circular, non-oval cross sections (such as represented by line 2 shown in FIG. 1a and 1b) such as a cylinder 302, a wedge shaped with at least one rounded edge, corner, or side (see systems 100 and 200 of FIG. 1 and FIG. 2, respectively) 304, a rectangular prism shaped 306, a star shaped 308, a heart shaped 310, triangular prism shaped, octagonal prism shaped, a flattened shape at least on one side, or other shapes. Furthermore, the molds may have fixed ends, removable ends, or no ends at all. In some embodiments, the mold may have a locking mechanism to keep the mold in a rigid form during the cooking and filling processes. A mixture filled mold, which can be made of different materials such as stainless steel, ceramic, aluminum, copper, a similar material, or any combination thereof, can be heated to a temperature and for a time sufficient to cook the raw mixture. The example molds of system 300 can be used to form a variety of shaped food products, including hot dogs, sausages, pressed meats, tofu, meat loaf, cheese, bean products, any combination thereof, and so forth.

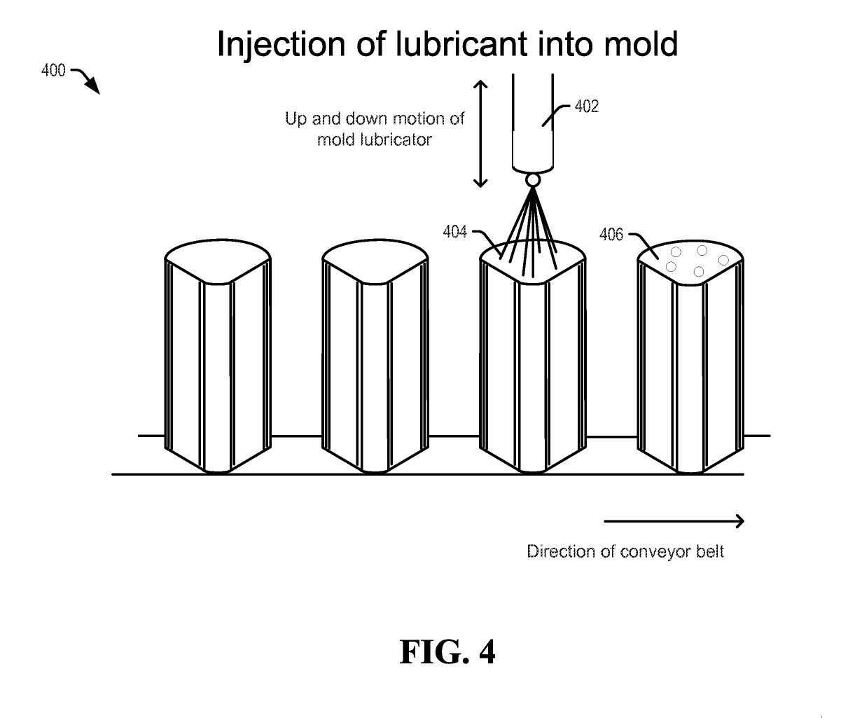

Referring to FIG. 4, embodiments of manufacturing systems and methods for custom shaped food products are shown and generally designated 400. In some embodiments, one may lubricate the molds so that the cooked mixture can be removed with minimal loss. In some examples, the molds can be coated with a non-stick substance; the coating may be deposited as part of a manufacturing process, and in some embodiments, may be reapplied as necessary. Non-stick substances and coatings can be permanent, semi-permanent, or temporary. For example, the non-stick substance or coating could be Polytetrafluoroethylene (PTFE, commonly known as Teflon®), a food-safe lubricating oil, or other material that allows the cooked mixture to not stick to a mold. The applicator 402 can inject, spray, or deposit the lubricant into the mold 404, such as by moving up or down to provide an even coating. Lubricating the molds can be done manually, but may also be done in an automated or quasi-automated process. The lubricated molds 406 can move onto the next step in the manufacture process, which can include filling the molds with the food mixture.

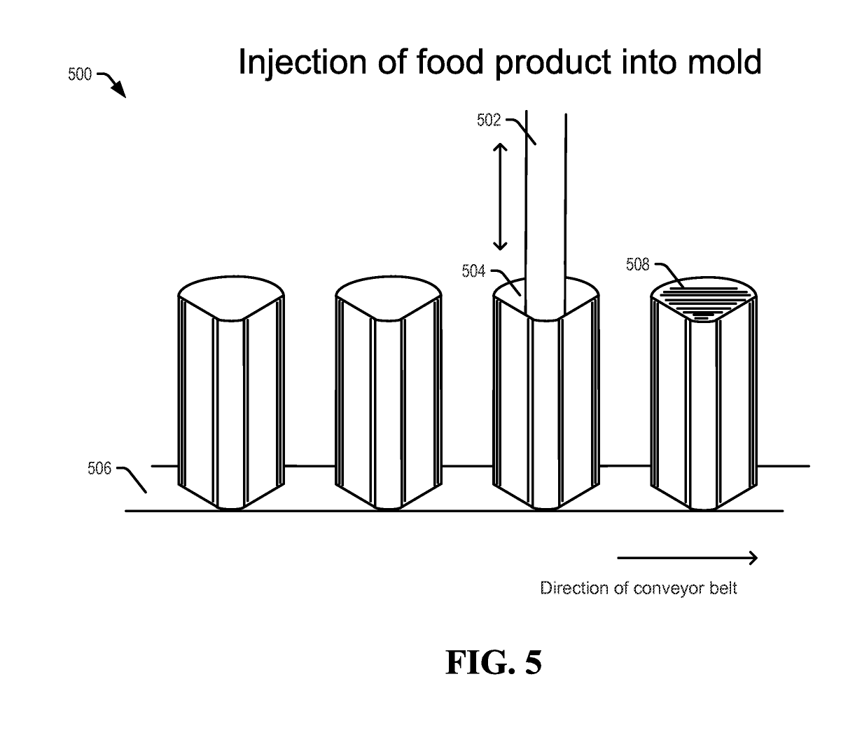

Referring to FIG. 5, embodiments of manufacturing systems and methods for custom shaped food products are shown and generally designated 500. When the molds have been lubricated, either via the example in method 400 or via other means such as a pre-existing coating, they can be filled with the uncooked mixture. The uncooked mixture can be deposited into the mold 504 via an injector 502. In some embodiments, however, the food product can be deposited into the mold 504 via other means, such as a gravity fed system. The molds can also be filled while at an angle or in a horizontal orientation. A conveyor belt 506 can transport the filled mold 508 to the next step in the manufacture process, which may include cooking the food mixture by heating it to achieve a cooked food mixture.

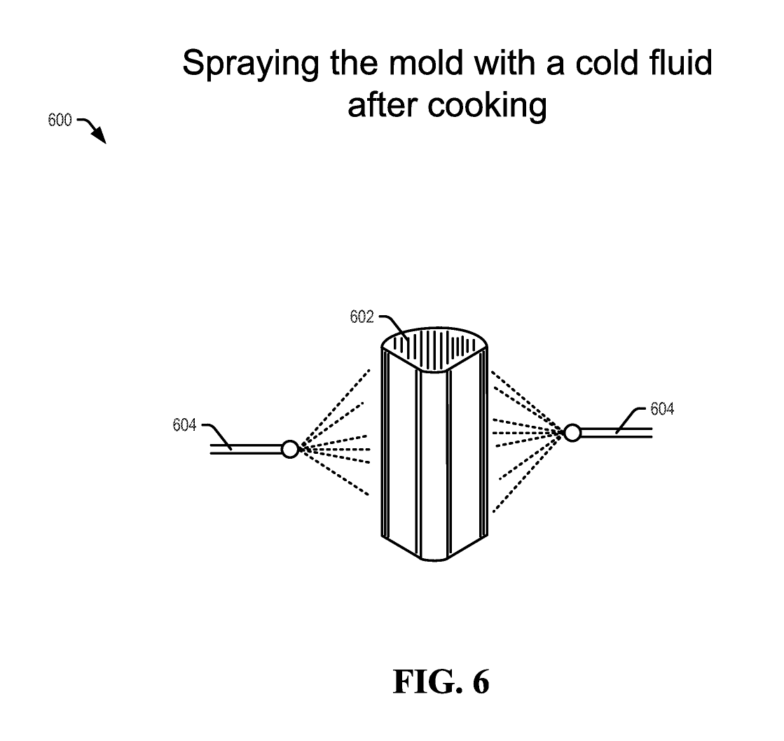

Referring to FIG. 6, embodiments of manufacturing systems and methods for custom shaped food products are shown and generally designated 600. After a mixture has been cooked, a process may quickly cool the mixture shortly after the cooking process has finished. In some embodiments, a hot mold containing the cooked mixture 602 can be cooled via sprayers 604. The sprayers 604 can spray cold liquid, such as water, salt water, or ethanol, or a cooling gas, such as air, nitrogen, oxygen, hydrogen, or any other substance that speeds cooling of the mold(s).

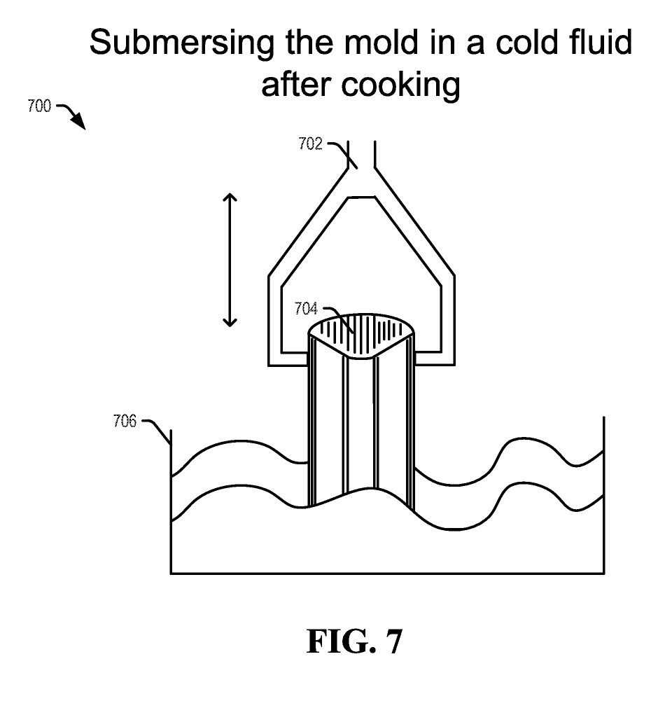

Other methods of cooling the cooked mixture include refrigeration, freezing, and liquid immersion. Referring to FIG. 7, embodiments of manufacturing systems and methods for custom shaped food products are shown and generally designated 700. A mold containing the cooked mixture 704 may be handled by a mechanical arm 702, clamp, magnet, or other device configured to hold the mold, transport it, and place it into a cold bath 706, which may be a liquid or gas as discussed above. When the cooked mixture 704 is sufficiently cool, it can be transported to a next step in the manufacturing process, which may include removal of the mixture from the mold. The system 700 can be automated, using a conveyor belt (not shown), or other manufacturing processes. In still other methods, the molds can be cooled as a conveyor belt takes them under running water, through tubs filled with liquid or gas, etc.

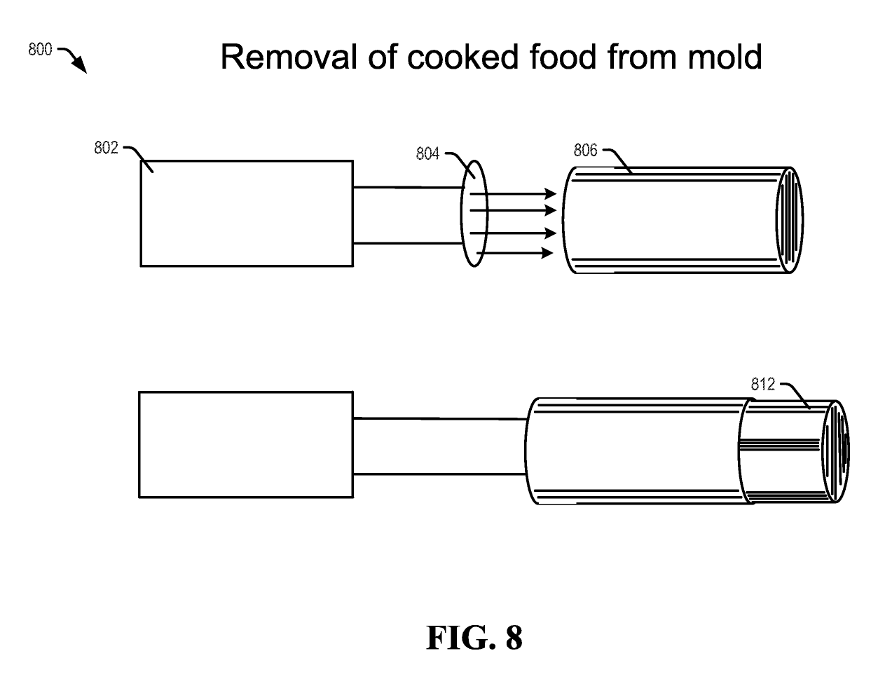

Referring to FIG. 8, embodiments of manufacturing systems and methods for custom shaped food products are shown and generally designated 800. When the food product has been cooked and chilled (See FIGS. 600 and 700), it may be removed from the mold. In the example of system 800, a motor 802, which may be hydraulic, magnetic, or have another drive system, can drive a plunger 804 into a mold 806. When the plunger 804 is inserted into the mold 806, the cooked mixture 812 can be pushed out.

In some cases, it may be beneficial for the plunger 802 to make maximal surface contact with the cooked mixture in the mold; the more contact the plunger 802 has with the cooked mixture 812, the more likely it may be that the cooked mixture can be removed from the mold with minimal damage. As a result, a shape of the plunger 804 and the opening of the case 806 may be substantially similar, except that the plunger 804 can be smaller than the opening of the mold 806. Once removed, the cooked mixture can be routed to another step in the manufacturing process, such as quality control or packaging.

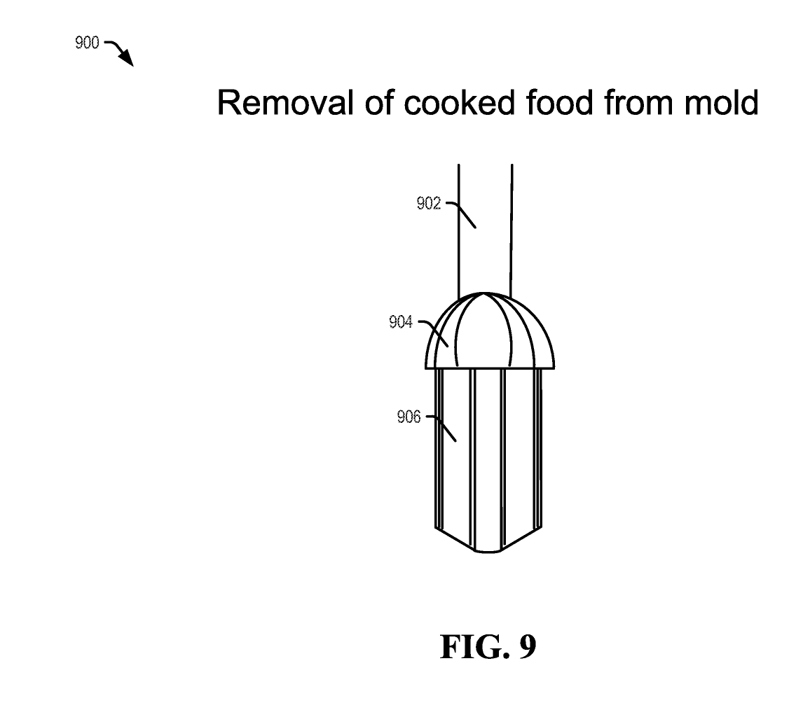

Referring to FIG. 9, embodiments of manufacturing systems and methods for custom shaped food products are generally designated 900. In some embodiments, the cooked mixture can be removed from the case by vacuum or plunger system. A vacuum or a plunger head 904, which might be connected to a pipe 902 of a shape sufficient to carry the cooked mixture, may suck, or pull, the mixture from the mold 906. The head 904 can be of a substantially similar shape as the mold 906 or the head 904 can be large enough to cover an exterior perimeter of a cross section of the mold 906. The head 904 can be detached and exchanged with different heads to accommodate molds of different shapes or sizes. Alternatively, the vacuum head 904 can be one shape, and there may be an adapter fitted to the head 904, the mold 906, or both to allow the head 904 to pull the cooked food product from the mold 906.

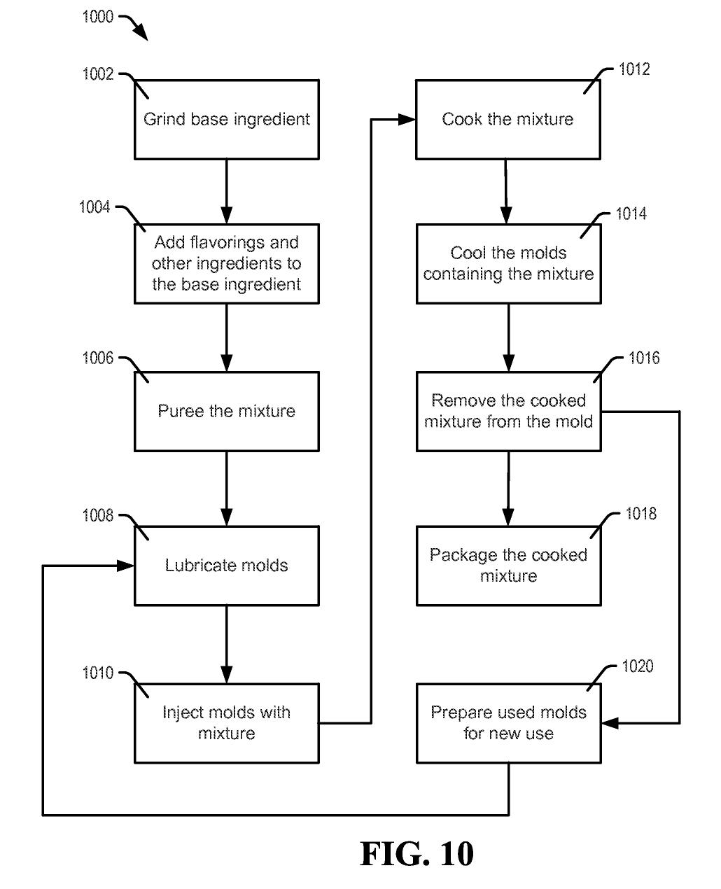

Referring to FIG. 10, a flowchart describing manufacturing systems and methods for custom shaped food products is shown and is generally designated 1000. The method 1000 can be an example implementation of the systems 100 and 200, and the methods 300 through 900. Furthermore, while the method 1000 is directed towards making hot dogs, it can be used or modified to make any food product requiring a mold, and may be used in automated, quasi-automated, or manual processes. Hot dogs can be made by grinding up a base ingredient, which may be meat or meatless, at 1002. Additional ingredients, such as flavorings, starches, binders, and spices can be added to the ground base to form a mixture. The mixture can be pureed at 1006 for a period of time, or until the mixture reaches a set consistency.

Molds may be coated with a food grade lubricant, at 1008. In some circumstances, such as when the surface of the molds have low coefficients of friction, or when the characteristics of the cooked mixture are such that the cooked mixture can be easily removed from the mold, the molds may not need a lubricant and step 1008 can be skipped. The mixture can be injected or otherwise deposited into the lubricated molds at 1010, and heated or cooked at 1012; cooking methods can include baking, steaming, boiling, microwaving, smoking, or any combination thereof.

When the mixture is removed from the heating source, an additional cooling process may be desirable to stop the mixture from further cooking inside the hot mold. The cooked mixture and mold may be cooled, at 1014, by a plethora of processes, including cold liquid baths, chilling in freezers, cold liquid or gas sprays, or other methods. The cooled mixture can be removed from the mold, at 1016, via methods such as pushing, pulling, shaking, peeling, etc. to provide hot dogs. For example, a mold may be cut off of or stripped from the mixture. Once the hot dogs have been removed from the mold, the method may include packaging at 1018; in some embodiments, the loose hot dogs may proceed to other stations prior to packaging, such as coloring, lacquering, flavoring, quality control, further cooking (e.g. deep frying, flame broiling), etc. In some cases, the used molds can be prepared for re-use at 1020.

All listed methods may be performed manually or in an automated or quasi-automated process. Additionally, the methods and systems listed herein may be used to make products of different sizes and shapes, and with different bases and ingredients.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A food product comprising: an elongated food product having a custom cross-sectional shape.

2. The food product of claim 1 further comprising the custom cross-sectional shape has a non-circular and non-oval cross section.

3. The food product of claim 1 further comprising the custom cross-sectional shape is a wedge shape with a rounded side.

4. The food product of claim 1 further comprising the custom cross-sectional shape is substantially a two-dimensional conical shape.

5. The food product of claim 1 comprising the elongated food product is a hot dog or sausage.

6. A food manufacturing process comprising:
adding a food mixture to an elongated mold;
heating the mold with the food mixture in it to achieve a cooked food mixture; and
removing the cooked food mixture to obtain an elongated food product.

7. The food manufacturing process of claim 6, wherein the elongated food product comprises a hot dog or sausage.

8. The food manufacturing process of claim 6, wherein the elongated food product has a non-circular and non-oval cross section.

9. The food manufacturing process of claim 6, wherein the mold is a non-organic material.

10. The food manufacturing process of claim 6, wherein the mold is a rigid synthetic material.

11. The food manufacturing process of claim 6, wherein the mold is an organic material.
